(19) United States
(12) Patent Application Publication
(10) Pub. No.: US 2003/0117017 A1
(43) Pub. Date: Jun. 26, 2003

(54) Track tension adjustment management system

(76) Inventor: Brian D. Hoff, East Peoria, IL (US)

Correspondence Address: CATERPILLAR INC., 100 N.E. ADAMS STREET, PATENT DEPT., PEORIA, IL, 616296490

(21) Appl. No.: 10/325,362

(22) Filed: Dec. 19, 2002

Related U.S. Application Data
(60) Provisional application No. 60/345,424, filed on Dec. 21, 2001.

(51) Int. Cl. B62D 55/14

(52) U.S. Cl. 305/143

(57) ABSTRACT

A track tensioning system for a track assembly having, an idler wheel, a drive wheel, a drive track entrained about the drive wheel and idler, and a hydraulic motor operable to advance the drive wheel. A drive circuit is operable to supply pressurized fluid to the hydraulic motor. An actuator coupled to the idler wheel has a travel chamber and a recoil chamber, and the recoil chamber is pressurized to urge the idler wheel in a first direction away from the drive wheel to tension the track. A controlled delivery mechanism in fluid communication with the drive circuit and the travel chamber of the actuator is operable to receive from the drive circuit pressurized fluid supplied to the hydraulic motor and responsively deliver a controlled quantity of fluid to the travel chamber of the actuator. The actuator is operable to reduce the track tension responsive to receipt of the controlled quantity of fluid.

This application claims the benefit of prior provisional patent application Serial No. 60/345,424 filed Dec. 21, 2001.

### TECHNICAL FIELD

This invention relates generally to a track tension adjustment mechanism and, more particularly, to a system for reducing tension on an idler wheel of endless track machine when the machine is traveling.

### BACKGROUND

A tracked work machine, such as a track-type tractor or excavator, is typically supported and propelled by a pair of undercarriage assemblies. Each of the pair of undercarriage assemblies includes an endless track chain having a plurality of interconnected articulating components or links. Each undercarriage assembly typically also includes a drive wheel or sprocket and one or more idler wheels. The track chain is advanced around the drive sprocket and the one or more idler wheels.

During operation of the work machine, it is necessary to maintain tension on the track chain in order to keep the chain from derailing or jumping between teeth on the sprocket. In order to maintain tension on the track chain, a tension adjustment mechanism such as a hydraulic cylinder or coiled spring is often included in the undercarriage assembly.

With regard to excavators, it is generally desirable to have the track chain relatively taut during performance of a digging or other type of work operation in order to prevent the excavator from rolling back and forth within the interior of the track chain as a result of recoil forces generated during performance of the work operation. When digging with a tight track chain, the machine feels more stable to the operator and less wear occurs to the track components. To create tension on the track chain, the hydraulic cylinder or the coiled spring of the tension adjustment mechanism urges the idler wheel away from the drive wheel, increasing the dimension of the undercarriage assembly which the track chain must encircle.

In contrast, it is generally desirable to have the track chain relatively loose during advancement or travel of an excavator. By loosening or otherwise decreasing tension on the track chain, wear on the components associated with the undercarriage assembly is reduced. This increases the efficiency and even the useful life of the excavator. To reduce tension in the track chain, the hydraulic cylinder or coiled spring of the tension adjustment mechanism urges the idler wheel toward the drive wheel or sprocket.

The tension adjustment mechanism also provides a recoil function in the track chain, accommodating temporary forces on the track such as when a rock or the like is ingested between the track and the wheels during advancement of the excavator. In these instances, the idler wheel is permitted to recoil toward the drive sprocket in order to accommodate the extra length the track must encircle in order to accommodate the rock without breaking.

U.S. Pat. No. 6,249,994 (“the '994 patent”) discloses a tensioning mechanism which decreases track tension by a predetermined amount when the machine is traveling. The '994 patent discloses a track tension assembly which, when the drive system is operated, supplies pressurized fluid to an accumulator in fluid communication with a recoil subchamber in a cylinder assembly attached to the idler wheel, but requires a relatively complex control arrangement.

The present invention is directed to solving one or more of the problems or disadvantages set forth above of current work machines.

### SUMMARY OF THE INVENTION

The present invention provides a track tensioning system for a track assembly having, an idler wheel, a drive wheel, a drive track entrained about the drive wheel and idler, and a hydraulic motor operable to advance the drive wheel. A drive circuit is operable to supply pressurized fluid to the hydraulic motor. An actuator coupled to the idler wheel has a travel chamber and a recoil chamber, and the recoil chamber is pressurized to urge the idler wheel in a first direction away from the drive wheel to tension the track.

A controlled delivery mechanism in fluid communication with the drive circuit and the travel chamber of the actuator is operable to receive from the drive circuit pressurized fluid supplied to the hydraulic motor and responsively deliver a controlled quantity of fluid to the travel chamber of the actuator. The actuator is operable to reduce the track tension responsive to receipt of the controlled quantity of fluid.

The present invention also provides a method of tensioning a track assembly having, an idler wheel, a drive wheel, a drive track entrained about the drive wheel and idler, and a hydraulic motor operable to advance the drive wheel.

An actuator is coupled to the idler wheel, the actuator having a recoil chamber and a travel chamber. The recoil chamber is pressurized to tension the track and pressurized fluid is supplied to a hydraulic motor operable to advance the drive wheel. A controlled quantity of fluid is delivered to the travel chamber of the actuator responsive to said supply of pressurized fluid to the hydraulic motor, operating the actuator to reduce the track tension.

### BRIEF DESCRIPTION OF THE DRAWINGS

A more complete appreciation of this invention will be understood by reference to the following detailed description when considered in conjunction with the accompanying drawings in which like reference symbols indicate the same or similar components, wherein:

FIG. 1 is a side elevational view of an excavator which incorporates an exemplary embodiment of the present invention therein;

FIG. 2 is an enlarged, partially cutaway side elevational view of the undercarriage assembly of the excavator of FIG. 1;

FIG. 3 is a schematic illustration of a track tensioning assembly according to an exemplary embodiment of the present invention; and

FIG. 4 is a schematic illustration of a track tensioning assembly according to another exemplary embodiment of the present invention.

### DETAILED DESCRIPTION

The invention as described below is applied to a hydraulic excavator. It should be appreciated that the present invention may be applied to any type of work machine having an endless track, such as a rubber belt or drive track chain, including, for example, track-type tractors, loaders, and military vehicles.

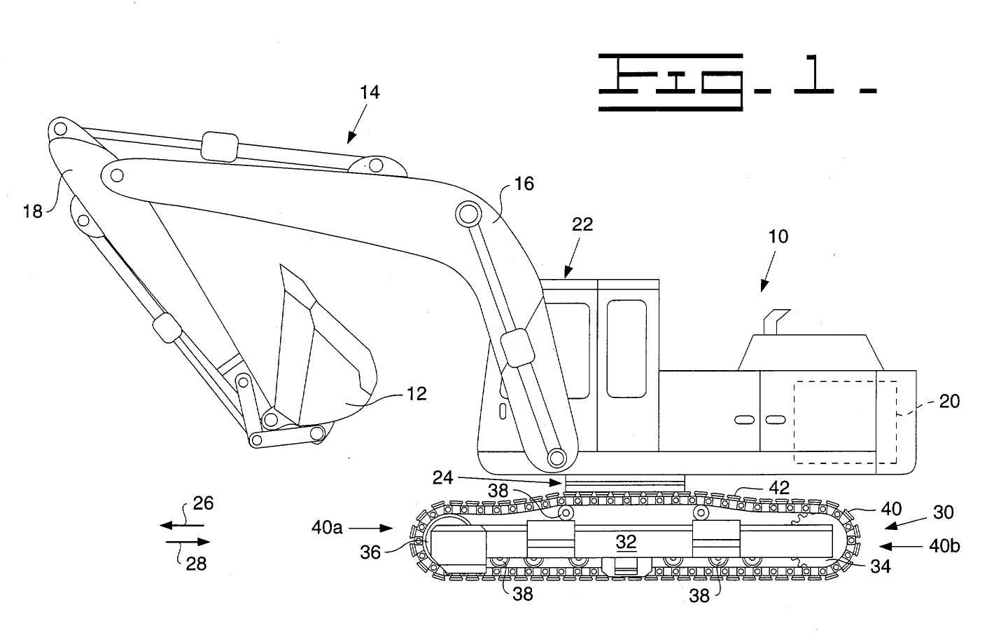

FIG. 1 illustrates a track-type work machine, for example, a hydraulic excavator 10, that is utilized to perform numerous work functions, such as digging and material movement. The excavator 10 may include a number of work implements, such as, for example, a hydraulically-powered bucket assembly 12, which is secured to an end of a boom assembly 14 having a boom arm 16 and a stick assembly 18. The excavator 10 further includes an engine such as, for example, a diesel engine 20, for providing the motive power for both advancing the excavator 10 and operating the bucket assembly 12 and the boom assembly 14.

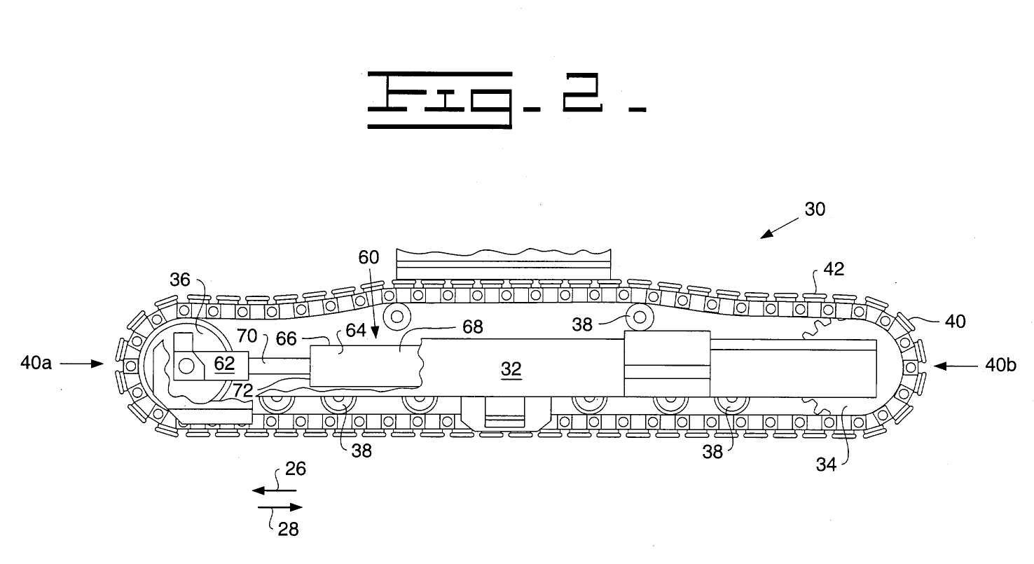

The excavator 10 also includes a pair of track assemblies, although only one is shown in FIGS. 1 and 2. Each track assembly 30 generally includes a frame assembly 32, a drive wheel 34, an idler wheel 36, and a number of midrollers 38. For each track assembly 30, a drive track 40, such as, for example, an endless track chain 42, may be driven by the drive wheel 34 so as to be advanced around the idler wheel 36 and each of the midrollers 38, thereby providing the motive power for advancing the excavator 10. It should be appreciated that drive wheel 34 may comprise a drive wheel which is frictionally engaged with the drive track 40 or a drive sprocket which is mechanically engaged with the drive track chain 40. In one embodiment, the idler wheel 36 is positioned at a first end 40a of the track assembly 30, while the drive wheel 34 is positioned at a second and opposite end 40b of the assembly. For simplicity of reference, the first end 40a at which the idler wheel 36 is positioned is commonly described as the “front” of the excavator 10 relative to a cab 22, while the second end 40b having the drive wheel 34 is described as the “rear”.

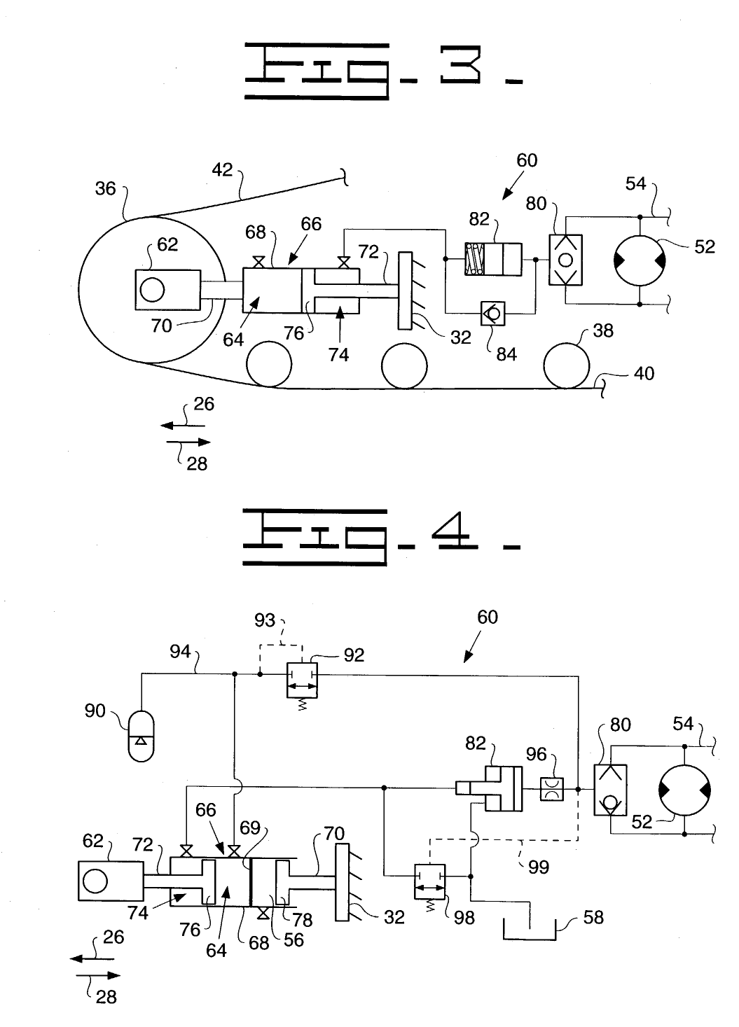

FIG. 3 is a schematic illustration of a track tensioning assembly 60 according to an exemplary embodiment of the present invention. To advance the excavator 10, mechanical output from the engine 20 (see FIGS. 1 and 2) is transmitted to the drive wheels 34 via a drive system fluid circuit 54 having a source of pressurized fluid such as a pump (not shown), and one or more hydraulic drive motors 52. Each hydraulic drive motor 52 drives at least one of the drive wheels 34 to advance the drive track 40 and, hence, the excavator 10. The drive system fluid circuit 54 supplies pressurized hydraulic fluid through the hydraulic motor 52 to advance the motor in either a forward or reverse direction, depending upon the direction of fluid flow through circuit 54 and motors 52.

As shown in FIG. 1, the excavator 10 also includes the cab 22 that is provided to enclose or otherwise house the devices associated with the excavator 10, which are utilized by an operator during operation of the excavator 10. In particular, the cab 22 houses an operator seat (not shown) and a number of control devices such as a control lever assembly (not shown) and a foot pedal assembly (not shown). The cab 22 is positioned on an undercarriage supported by the track assemblies of the excavator 10 on a swivel 24. The swivel 24 allows the cab 22 to be turned in both the clockwise and counterclockwise directions.

In addition to the engine 20, other components of the excavator 10 positioned above the swivel 24 typically include the pressurized fluid source and one or more return tanks or fluid reservoirs 58 (see FIG. 4). One skilled in the art understands that the components positioned above the swivel 24 are connected with the components of the undercarriage and each track assembly 30 through various conventional fluid lines that travel through the swivel 24.

As shown in more detail in FIG. 2, each track assembly 30 includes a track tensioning system 60. The track tensioning system 60 is configured to (1) provide a relative taut track configuration in order to prevent the excavator 10 from rolling back and forth during a work operation and (2) loosen the tension on the drive track 40 during advancement of the excavator 10 in order to decrease undercarriage component wear.

The track tensioning system 60 may include a tension actuator 66 having a yoke 62 secured thereto. As shown in FIGS. 2 and 3, the idler wheel 36 is rotatably coupled to the yoke 62. Movement of the yoke 62 and hence the idler wheel 36 in a first direction 26 of FIGS. 1-4, away from the drive wheel 34, increases tension of the drive track 40. Conversely, movement of the yoke 62 and hence the idler wheel 36 in a second direction 28 toward the drive wheel 34 decreases tension of the drive track 40.

In one exemplary embodiment illustrated in FIG. 3, tension actuator 66 may be a hydraulic cylinder having a cylinder housing 68, secured by a linking member 70 extending therefrom to the yoke 62 associated with the idler wheel 36. A rod 72, having a first piston 76 connected at one end, is secured at an opposite end to the frame assembly 32, such that cylinder housing 68 is moveable relative to the fixed first piston 76. First piston 76 divides cylinder housing 68 into a recoil chamber 64 and a travel chamber 74.

Recoil chamber 64 contains a fixed quantity of a pressurized fluid, such as a compressible liquid or gas, urging housing 68 and idler wheel 36 in the first direction 26 away from the drive wheel 34 and tensioning the track 40. As used herein, the term compressible liquid refers to a liquid elastomer such as silicon oil, which may undergo a significant decrease in volume when mechanically compressed or pressurized. Working fluids commonly used in hydraulic machines are relatively incompressible, so that an accumulator is conventionally used to store pressurized hydraulic fluid as further discussed below in relation to an embodiment illustrated in FIG. 4.

The pressurized fluid in recoil chamber 64 additionally functions as a spring, permitting recoil of the idler wheel 36 in the second direction 28 toward the drive wheel 34 responsive to an external force such as a shock or rock trapped in the track. As the idler wheel 36 recoils in the direction 28, corresponding movement of the cylinder housing 68 along fixed piston 76 reduces the size of recoil chamber 64. The reduced size of recoil chamber 64 increases the pressure of the entrained fluid, providing a corresponding increase to further recoil. In the embodiment illustrated in FIG. 3, recoil chamber 64 is preferably pressurized well above atmospheric with a fixed quantity of an inert gas, such as nitrogen.

An advantage of the actuator orientation embodiment illustrated in FIG. 3, with a rod and piston affixed to the frame and a movable cylinder housing, is that the seal between the rod 72 and the cylinder housing 68 is physically removed from near the idler wheel into a more protected environment.

Accordingly, when the idler wheel kicks up debris from the ground, the seal is not positioned where the debris is kicked up.

In an alternative exemplary embodiment illustrated in FIG. 4, actuator 66 is oriented so that first piston 76 is instead connected through rod 72 to yoke 62 associated with the idler wheel. Cylinder housing may be connected via linking member 70 to frame 32, permitting movement of piston 76 relative to a fixed cylinder housing 68 (not shown). Optionally, linking member 70 may be connected at one end to a second piston 78 moveable within cylinder housing 68 as illustrated, or even within a second cylinder housing rigidly affixed to housing 68. A wall 69 may bisect cylinder housing 68, cooperating with second piston 78 to form an actuator adjustment chamber 56 within the housing. A relatively incompressible fluid, such as grease, may be added to or withdrawn from chamber 56 during maintenance to reposition the relatively fixed housing 68 as the track chain 40 stretches or is replaced.

Returning now to FIG. 3, the drive circuit 54 is operable to supply pressurized fluid to the hydraulic motor 52. A shuttle valve assembly 80 is connected in parallel with the motor 52, so that a portion of the pressurized fluid is received by controlled delivery mechanism 82. Shuttle valve 80 operates as a two way check valve to prevent pressurized fluid from bypassing motor 52, and taking power away from the motor. For example, fluid entering shuttle valve 80 from the top of drive circuit 54, referred to here for simplicity as forward flow to the motor 52, will close the bottom check and permit only so much flow as controlled delivery mechanism 82 can accommodate. Likewise flow entering shuttle valve 80 from the bottom of drive circuit 54, referred to here for simplicity as reverse flow to the motor 52, will close the top check and permit only so much flow as controlled delivery mechanism 82 can accommodate

Controlled delivery mechanism 82 delivers a controlled quantity of fluid to travel chamber 74 responsive to pressurized fluid from drive circuit 54, in turn pressurizing travel chamber 74. A fluid pressure in travel chamber 74 greater than the pressure in recoil chamber 64 will cause the chamber 74 to enlarge while chamber 64 contracts. In the embodiment illustrated in FIG. 3, the increased pressure in travel chamber 74 causes cylinder housing 68 to move in a second direction 28, in turn causing idler wheel 36 attached by yoke 62 and linking member 70 to the housing to move in the direction 28 toward the drive wheel 34, and thereby reducing the track tension.

It should be noted that the increased pressure in the travel chamber is balanced by a corresponding increased pressure in the recoil chamber as the fluid or gas is forced to occupy less space, in turn raising the threshold of external forces that the recoil chamber can absorb. While it would be possible to supply pressurized fluid from drive circuit directly to the travel chamber 74, the drive circuit pressure may become very high under high drawbar loads, raising the recoil pressure beyond the desirable range where it can absorb normal external forces. Accordingly, controlled delivery mechanism 82 may be provided to limit the total quantity of fluid which may be provided to travel chamber 74, regardless of the drive pressure.

According to the exemplary embodiment illustrated in FIG. 3 mechanism 82 may be a cylinder and piston. The cylinder is fluidly coupled to receive pressurized fluid from the drive circuit 52 at a first end, in turn moving the piston within the cylinder of the mechanism 82 and responsively discharge a controlled quantity of fluid out an opposite end of the cylinder. The discharged fluid is supplied to the travel chamber 74 to reduce the track tension as discussed above. It should be appreciated that regardless of how high the pressure in the drive circuit rises, the mechanism 82 prevents any more fluid from being discharged once the piston reaches the stops at the opposite end of the cylinder.

When pressurized fluid is no longer supplied to the drive motor 52 and mechanism 82 through shuttle valve assembly 80 (ie. travel is stopped), fluid flows back from the travel chamber into the opposite end of the hydraulic cylinder of mechanism 82, pushing the piston back to the first end and generally depressurizing the travel chamber. It should be appreciated that under normal conditions, the total quantity of fluid in both the travel chamber and left hand side of mechanism 82 remains substantially constant, moving from one to the other.

A valve 84, such as a check valve, is nonetheless provided to permit fluid which can not be accommodated back in the mechanism 82 to flow back into drive circuit 54 when the travel chamber is depressurized.

Turning once again to an exemplary embodiment illustrated in FIG. 4, controlled delivery mechanism 82 may also be a hydraulic amplifier, to insure sufficient pressure can be created in travel chamber 74 to reduce the tension on the track even under low drive pressure conditions in drive circuit 54, such as a free running or downhill travel. A hydraulic amplifier may be a cylinder and piston arrangement in which one end has a first diameter greater than a second diameter at the opposite end. In a well known manner, pressurized fluid impinging on the larger diameter end creates a force on the piston which is distributed over the surface area of the smaller diameter end, creating an increased pressure at the smaller diameter end. An orifice 96 may also be provided between the shuttle valve assembly 80 and mechanism 82 to limit the rate at which fluid can flow into or out of mechanism 82, and consequently the rate at which the track tension may change.

A valve 98 may be placed in communication with travel chamber 74, to perform a function similar to that of check valve 84 in the embodiment illustrated in FIG. 3. Pressurized fluid on drive circuit 54 is available through pilot line 99 to keep valve closed during travel. When pressurized fluid is no longer provided on drive circuit 54, valve 98 may open and permit fluid to travel either direction between travel chamber 74 and fluid reservoir 58. An intermediate chamber in hydraulic transformer 82 may also be fluidly connected with fluid reservoir 58, since that chamber does not contribute to the pressure amplification but may receive fluid leaking across the piston seals.

The embodiment illustrated in FIG. 4 also differs from that in FIG. 3. by replacing the pressurized gas in recoil chamber 64 with a pressurized fluid in communication with an accumulator 90 over a line 94. A valve 92 in fluid communication with the drive circuit may recharge the accumulator when the accumulator pressure falls below a predetermined value. For example, when the fluid pressure in the accumulator and available on pilot line 93 to the valve 93 drops below the force provided by a spring on the opposite side of the valve, the valve will open, allowing pressurized fluid from the drive circuit 54 to recharge the accumulator and close the valve 92.

Industrial Applicability

The present invention allows for varying the force to be applied to the idler wheel 36 based on travel of a tracked machine, without the need for electronic sensors or electro-hydraulic valves. When the machine is traveling, via a mechanism which responsively supplies a controlled volume of fluid to a travel chamber of the actuator providing tension and recoil to the idler wheel.

With respect to the excavator of the exemplary embodiment, drive fluid pressure is utilized to reduce the track tension without the need to provide additional hydraulic fluid or electrical lines through the swivel mount.

It should be appreciated that various features from the embodiments illustrated in FIGS. 3 and 4 could be combined differently with one another, or with functionally equivalent elements, without departing from the spirit and scope of the present invention. While certain present preferred embodiments of the invention and certain present preferred methods of practicing the same have been illustrated and described herein, it is to be distinctly understood that the invention is not limited thereto but may be otherwise variously embodied and practiced within the scope of the following claims.

What is claimed is:

1. A track tensioning system for a track assembly having, an idler wheel, a drive wheel, a drive track entrained about the drive wheel and idler, and a hydraulic motor operable to advance the drive wheel, the system comprising:
a drive circuit operable to supply pressurized fluid to the hydraulic motor;
an actuator coupled to the idler wheel, the actuator having a travel chamber and a recoil chamber, wherein said recoil chamber is pressurized to urge the idler wheel in a first direction away from the drive wheel to tension the track; and
a controlled delivery mechanism in fluid communication with the drive circuit and the travel chamber of said actuator, said mechanism operable to receive from said drive circuit pressurized fluid supplied to the hydraulic motor and responsively deliver a controlled quantity of fluid to said travel chamber of said actuator, wherein said actuator is operable to reduce the track tension responsive to receipt of said controlled quantity of fluid.

2. The system of claim 1, wherein said controlled delivery mechanism includes a cylinder and piston.

3. The system of claim 2, wherein said cylinder is fluidly coupled to receive said pressurized fluid from the drive circuit at a first end, said pressurized fluid operable to move said piston and responsively discharge said controlled quantity of fluid out an opposite end of said cylinder, wherein said travel chamber is fluidly coupled to said opposite end.

4. The system of claim 2, wherein said cylinder and piston comprise a hydraulic amplifier.

5. The system of claim 4, wherein said piston has a first diameter and a second diameter smaller than said first diameter.

6. The system of claim 1, further including a shuttle valve assembly interposed said drive circuit and said controlled delivery mechanism.

7. The system of claim 1, where said travel chamber is operable to urge the idler wheel in a second direction toward the drive wheel responsive to receipt of said controlled quantity of fluid.

8. The system of claim 1, said actuator including a cylinder housing and a first piston moveable in said cylinder housing, said first piston dividing at least a portion of said cylinder housing into said recoil chamber and said travel chamber.

9. The system of claim 8, said actuator further including a rod securing said first piston to a frame of the track assembly, and a linking member connecting said cylinder housing with the idler wheel, wherein said cylinder housing is movable relative to the frame.

10. The system of claim 8, said actuator further including a rod connecting said first piston with the idler wheel, wherein the idler wheel is movable relative to said cylinder housing in said first direction.

11. The system of claim 10, said actuator further including a wall bisecting said hydraulic cylinder and a second piston secured by a linking member to a frame of the track assembly, said wall and said second piston forming an actuator adjustment chamber, and wherein a position of said cylinder housing is relative to the frame is determined by a quantity of fluid in said actuator adjustment chamber.

12. The system of claim 1, wherein said recoil chamber contains a pressurized gas.

13. The system of claim 1, further including an accumulator in fluid communication with said recoil chamber.

14. The system of claim 13, further including a valve in fluid communication with said drive circuit and said accumulator for recharging the accumulator when the accumulator pressure falls below a predetermined value.

15. A method of tensioning a track assembly having, an idler wheel, a drive wheel, a drive track entrained about the drive wheel and idler, and a hydraulic motor operable to advance the drive wheel, comprising:
coupling an actuator to the idler wheel, the actuator having a recoil chamber and a travel chamber;
pressurizing the recoil chamber to tension the track
supplying pressurized fluid to a hydraulic motor operable to advance the drive wheel;
delivering a controlled quantity of fluid to the travel chamber of the actuator responsive to said supply of pressurized fluid to the hydraulic motor; and
operating the actuator to reduce the track tension responsive to receipt of said controlled quantity of fluid.

16. The method of claim 15, said step of delivering a controlled quantity of fluid further including:
placing a cylinder and piston in fluid communication between the hydraulic motor and the travel chamber,
moving the piston in the cylinder responsive to the pressurized fluid supplied to the hydraulic motor,
delivering said controlled quantity of fluid from said cylinder to the travel chamber of the hydraulic actuator in proportion to the movement of the piston.

17. The method of claim 15, wherein said step of operating the actuator to reduce the track tension includes urging the idler wheel in a second direction toward the drive wheel responsive to receipt of said controlled quantity of fluid.

18. The method of claim 17, further including pressurizing the travel chamber to move a cylinder housing of the actuator toward a frame of the track assembly.

19. The method of claim 17, further including pressurizing the travel chamber to retract a rod and piston of the actuator.

20. A track assembly, comprising:
a drive track;
an idler wheel;
a drive wheel;
a hydraulic motor coupled to the drive wheel and operable to advance the drive track around the drive wheel and the idler wheel;
a drive circuit operable to supply pressurized fluid to said hydraulic motor;
an actuator coupled to the idler wheel for tensioning the track, the actuator having a recoil chamber and a travel chamber; and
a controlled delivery mechanism in fluid communication with the drive circuit and the travel chamber of said actuator, said mechanism operable to receive from said drive circuit pressurized fluid supplied to said hydraulic motor and responsively deliver a controlled quantity of fluid to said travel chamber of said actuator, wherein said actuator is operable to reduce the track tension responsive to receipt of said controlled quantity of fluid.

21. A tension actuator, comprising:
a cylinder housing;
a piston movable within said housing, said piston dividing said housing into a travel chamber and a recoil chamber; and
a rod connected to said piston, wherein said recoil chamber contains a fixed quantity of a pressurized fluid for urging said piston in a first direction, and said travel chamber is adapted to receive a variable quantity of hydraulic oil for adjusting a position of said rod and piston and a pressure of said pressurized fluid.
